(19) United States
(12) Patent Application Publication
(10) Pub. No.: US 2018/0182040 A1
(43) Pub. Date: Jun. 28, 2018

(54) SYSTEM AND METHOD FOR OPTIMIZING THE SELECTION OF PERMANENT LIFE INSURANCE POLICIES FOR USE IN LEVERAGE LIFE INSURANCE STRUCTURES

(71) Applicant: yGen Capital Inc., Ottawa (CA)

(72) Inventor: Rodney Clark, Westmount (CA)

(21) Appl. No.: 15/848,710

(22) Filed: Dec. 20, 2017

Related U.S. Application Data
(60) Provisional application No. 62/438,718, filed on Dec. 23, 2016.

(51) Int. Cl. G06Q 40/08; G06Q 40/00

(52) U.S. Cl. CPC G06Q 40/08; G06Q 40/12

(57) ABSTRACT

The present invention provides a system and method that allows a permanent insurance selection optimization platform administrator to control and monitor the permanent insurance selection optimization platform. The permanent insurance selection optimization platform administrator may input a raw data set from at least one insurance provider (including the source data for a permanent life insurance policy), and condition of credit and cost-of-funds data from a lender into the insurance selection optimization platform.

### RELATED APPLICATIONS AND INCORPORATION BY REFERENCE

This application claims the benefit of and priority to U.S. Provisional Application No. 62/438,718 filed on Dec. 23, 2016.

The foregoing applications, and all documents cited therein or during their prosecution (“appin cited documents”) and all documents cited or referenced in the appin cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention. More specifically, all referenced documents are incorporated by reference to the same extent as if each individual document was specifically and individually indicated to be incorporated by reference.

### FIELD OF THE INVENTION

The present invention pertains to the field of permanent life insurance and in particular to optimizing the selection of permanent life insurance policies.

### BACKGROUND OF THE INVENTION

Leveraged life insurance structures require permanent life insurance with cash value owned by a client who can afford the premiums and who can afford debt-servicing the structure, and a willing lender.

Optimizing leverage life insurance structures requires selecting the best possible permanent life insurance policy for each measuring life. This involves selecting a policy from any number of insurers for its internal metrics such as net cost of pure insurance (also referred to as “NCPI” herein), guaranteed dividends, and amount of permitted over funding. It also involves using various credit conditions and various cost-of-funds and client tax rates, and demonstrating a clear internal rate of return (also referred to as “IRR” herein) benefit for the client.

There currently is no system or method which can compare the net benefits of a leveraged life insurance structure in an objective and neutrally-verifiable manner. There are in-market tools for cost-efficient pricing of term insurance (such as Kanetix.ca™ for example), but these are basic tools which select a policy based on a paid premium for a set amount of insurance for a set term. There are no tools to select a policy based on leveraged life design.

Therefore there is a need for a system and method that optimizes the selection of permanent life insurance policies delivering results targeted to address the needs of the life insurance agent, the client, the client's accountant, the lender, and third party investors who would purchase the derivative financial instruments sold by the lender backed by the cash value assigned to it from the client.

This background information is provided to reveal information believed by the applicant to be of possible relevance to the present invention. No admission is necessarily intended, nor should be construed, that any of the preceding information constitutes prior art against the present invention.

Citation or identification of any document in this application is not an admission that such document is available as prior art to the present invention.

### SUMMARY OF THE INVENTION

An object of the present invention is to provide a method for optimizing the selection of permanent life insurance policies for use in leverage life insurance structures. In accordance with an aspect of the present invention, at least one raw data set from at least one insurance provider is entered into a permanent insurance selection optimization platform input interface; inputting at least one condition of credit and cost-of-funds data from a lender into a permanent insurance selection optimization platform input interface; running a selection module to complete the optimization of the selection of permanent life insurance policies; generating a result specifying the net annual cost to a client in all of the tested years; generating a result specifying the internal rate of return delivered to the client for each of the tested years based on their net cost of funds; generating a result specifying the collateral required by the lender to satisfy credit conditions through all tested years; generating a result specifying the interpolated debt service coverage ratio for the client for all tested years; generating a result specifying the excess cash value on the lender's balance sheet through all tested years; generating a result specifying the actuarially risk-weighted for the lender to put same on it's balance sheet as part of Tier 2 capital; conglomerating risk-weighted balance sheet assets based on the generated results; and informing the lender of the amount of risk-weighted assets which can be securitized.

In accordance with another aspect of the present invention, there is provided a system for optimizing the selection of permanent life insurance policies for use in leverage life insurance structures. The system will utilize at least one client seeking a permanent life insurance policy; at least one lender seeking to leverage life insurance structures; at least one insurance provider desiring to provide a client with a permanent life insurance policy; a permanent insurance selection optimization platform administrator; a permanent insurance selection optimization platform further which may comprise a permanent insurance selection optimization platform user interface, and at least one selection module; and at least one database configured to store information related to the at least one client, the at least one lender, the at least one insurance provider, the insurance selection optimization platform, the permanent insurance selection optimization platform user interface, and the at least one selection module.

Accordingly, it is an object of the invention not to encompass within the invention any previously known product, process of making the product, or method of using the product such that Applicants reserve the right and hereby disclose a disclaimer of any previously known product, process, or method. It is further noted that the invention does not intend to encompass within the scope of the invention any product, process, or making of the product or method of using the product, which does not meet the written description and enablement requirements of the USPTO (35 U.S.C. § 112, first paragraph) or the EPO (Article 83 of the EPC), such that Applicants reserve the right and hereby disclose a disclaimer of any previously described product, process of making the product, or method of using the product. It may be advantageous in the practice of the invention to be in compliance with Art. 53(c) EPC and Rule 28(b) and (c) EPC. Nothing herein is to be construed as a promise.

It is noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the invention.

These and other embodiments are disclosed or are obvious from and encompassed by, the following Detailed Description.

### BRIEF DESCRIPTION OF THE FIGURES

The patent or application file contains at least one drawing executed in color. Copies of this patent or patent application publication with color drawing(s) will be provided by the Office upon request and payment of the necessary fee.

The following detailed description, given by way of example, but not intended to limit the invention solely to the specific embodiments described, may best be understood in conjunction with the accompanying drawings.

Embodiments of the present invention will be better understood in connection with the following Figures, in which:

FIG. 1 illustrates an example of the permanent insurance selection optimization platform input interface;

FIG. 2 illustrates a table illustrating the costs of funds and net cost of funds paid by a client over a forty year period, at variable lending interest rates;

FIG. 3 illustrates a table of sample blended raw data from various life insurance providers for various ages of an insurance applicant;

FIG. 4 illustrates a table of the permanent insurance selection optimization platform benefits to a lender for clients from loan inception through the subsequent 40 years; and

FIG. 5 illustrates a table of the debt service cover ratio (also referred to as “DSCR” herein) over a forty year period.

### DETAILED DESCRIPTION OF THE INVENTION

The present invention provides a system and method that allows a permanent insurance selection optimization platform administrator to control and monitor the permanent insurance selection optimization platform. The permanent insurance selection optimization platform administrator may input a raw data set from at least one insurance provider (including the source data for a permanent life insurance policy), and condition of credit and cost-of-funds data from a lender into the insurance selection optimization platform. The platform will automatically generate results specifying the net annual cost to a client in each of the tested years; the internal rate of return delivered to the in each of the tested years based on their net cost of funds, the collateral required by the lender to satisfy credit conditions through all tested years; the interpolated debt service coverage ratio for the client for each of the tested years; the excess cash value on the lender's balance sheet through each of the tested years; and the actuarially risk-weighted for the lender to put same on its balance sheet as part of Tier 2 capital. Risk-weighted balance sheet assets are conglomerated and the lender is informed of the amount of risk-weighted assets which can be securitized.

Unless defined otherwise, all technical and scientific terms used herein have the same meaning as commonly understood by one of ordinary skill in the art to which this invention belongs.

The present invention provides a system and method that allows a permanent insurance selection optimization platform administrator to control and monitor a permanent insurance selection optimization platform (also referred to as “PISOP” herein). The permanent insurance selection optimization platform administrator may input a raw data set from at least one insurance provider (including the source data for a permanent life insurance policy), and condition of credit and cost-of-funds data from a lender into the insurance selection optimization platform user interface. The platform will automatically generate results specifying the net annual cost to a client in each of the tested years; the internal rate of return delivered to the in each of the tested years based on their net cost of funds, the collateral required by the lender to satisfy credit conditions through all tested years; the interpolated debt service coverage ratio for the client for each of the tested years; the excess cash value on the lender's balance sheet through each of the tested years; and the actuarially risk-weighted for the lender to put same on it's balance sheet as part of Tier 2 capital. Risk-weighted balance sheet assets are conglomerated and the lender is informed of the amount of risk-weighted assets which can be securitized.

In one embodiment the client may be but is not limited to an individual, group of individuals, partnership, corporation, institution, or otherwise as would be understood by someone skilled in the art, interested in obtaining a permanent life insurance policy.

In another embodiment the permanent insurance selection optimization platform administrator (also referred to as the “PISOPA” herein) may be but is not limited to an individual, group of individuals, corporation, financial institution, or otherwise as would be understood by someone skilled in the art, that controls and monitors the permanent insurance selection optimization platform.

In an additional embodiment the insurance provider may be but is not limited to an individual, group of individuals, partnership, institution, or otherwise as would be understood by someone skilled in the art desiring to provide a client with a permanent life insurance policy.

In another embodiment the lender may be but is not limited to an individual, group of individuals, partnership, financial institution, or otherwise as would be understood by someone skilled in the art seeking to leverage life insurance structures.

In one embodiment the PISOP will utilize a PISOP user interface and a selection module. The PISOP user interface will allow the PISOPA to enter information into the PISOP, which will impact the selection module. The selection module will perform various analysis, manipulation and operations such as but not limited to the determination of additional collateral required by a lender, the net cost of insurance through all years (which is financing cost less deductible carry costs, less deductible net cost of pure insurance, less deductible fees and charges), the internal rate of return delivered by the program in all years, and the CDA credits available in all years, in order to use the data inputted by the PISOPA in the PISOP user interface. This analysis, manipulation and operations will provide information that allows for optimization of the selection of permanent life insurance policies for use in leverage life insurance structures.

In an additional embodiment the PISOP will provide for the creation of derivative financial instruments created by the purchase of permanent life insurance policies by a client using the PISOP. These derivative financial instruments may then be sold by the lender, as backed by the cash value assigned to it from the client. Proper actuarial risk-weighting of cash value in policies assigned to the lender will allow the lender to identify the discounted cash value as part of Tier 2 capital. Tier 2 Capital is augmented by the lender's trading multiple (as permitted by regulations). With proper risk weighting of the cash value, the lender will be able to book loans using a multiple of these Tier 2 assets, and in turn sell instruments backed by same.

In another embodiment the PISOPA will be able to utilize the selection module to optimize the selection of permanent life insurance policies for use in leverage life insurance structures in an objective and neutrally-verifiable manner. This selection will deliver results targeted to address the needs of the insurance provider, the client, the client's accountant, the lender, third party investors or other entities as would be understood by someone skilled in the art, which would purchase the derivative financial instruments sold by the lender backed by the cash value assigned to it from the client.

In another embodiment the PISOP will utilize a database configured to store information including but not limited to information related to the clients, lenders, insurance providers, PISOP, PISOP user interface, PISOP selection module, or otherwise as would be understood by someone skilled in the art. This information may be accessed in order to inform the system.

In one embodiment the PISOPA will impose transactional fees upon a user of the PISOP such as but not limited to a client, lender, insurance provider, third party or other entity as would be understood by someone skilled in the art. These transactional fees may be for use of at least a portion of the PISOP, and may be imposed in various ways as would be understood by someone skilled in the art. The PISOPA will be able to control access to particular portions of the PISOP, and will be able to monitor use of the PISOP.

In another embodiment a PISOP user pay for subscription application for use on a personal computing device and accessible online, will be offered both for retail client and for life insurance providers (such as agents) in order to allow for efficient policy selection. Through the application, a customer/agent may fills out an application, and is asked to provide information and documents for adjudication based on the requirements of participating insurance providers and lenders. The applicant may have different life insurers and lenders bid on their file, choose the policy and lender, have a shared portal to upload documents, manage and have visibility into the due diligence process associated with loan and policy approval, and then bind the policy and loan.

In another embodiment an application for use on a personal computing device and accessible online will enable a lender to define the universe of acceptable policies for use as collateral, in order to inform the lender of the forward actuarial-discounted value of the collateral which will be counted as part of the lender's Tier 2 capital, as well as the additional collateral required to satisfy the lender's security requirements.

In another embodiment the PISOPA will administer the PISOP, including but not limited to the functionality, use, access, application, monitoring, and otherwise of the PISOP as would be understood by someone skilled in the art.

In one embodiment the PISOP may be accessed and utilized by PISOP users by connecting to one or more communication networks which may comprise one or more computing devices, one or more software applications, one or more online services, one or more databases, one or more cloud based services, one or more software applications extensions, one or more multimedia services, plug-ins, or add-ons, or any online software device, or any combination thereof.

In one embodiment the PISOPA will enter a raw data set from an insurance provider into a PISOP user interface. The PISOPA will also enter a condition of credit and cost-of-funds data from a lender into the PISOP input interface. The PISOPA will then run the PISOP selection module to complete the optimization of the selection of permanent life insurance policies. This is accomplished by illustrating the optimal policy, the optimal number of years to fund a policy, with the optimal amount of permitted over-funding, all verified by the objective analysis of the internal rate of return, which may be calculated as DB divided by (the cost of funds less the deducible interest expenses less the deductible net cost of pure insurance). The PISOP selection module will then generate various results that act to optimize the selection of permanent life insurance policies for use in leverage life insurance structures. These results may then be collected, analysed, and used by the PISOPA to provide guidance. Finally the PISOPA may then provide the results and/or guidance to inform other PISOP users.

In another embodiment the raw data set from an insurance provider entered into a PISOP user interface by the PISOPA will include, but not be limited to the source data for a permanent life insurance policy, or other information as understood by someone skilled in the art.

In an additional embodiment, the PISOPA will enter additional data such as but not limited to the number of years tested, financial inputs, or otherwise as would be understood by someone skilled in the art, into the PISOP user interface, which will affect the various results generated by the PISOP selection module.

In one embodiment the various results generated by the PISOP selection module will include, but are not limited to specifying the net annual cost to a client in all of the tested years, the internal rate of return delivered to the client for each of the tested years based on their net cost of funds, the collateral required by the lender to satisfy credit conditions through all tested years, the interpolated debt service coverage ratio for the client for all tested years, the excess cash value on the lender's balance sheet through all tested years, the actuarially risk-weighted for the lender to put same on its balance sheet as part of Tier 2 capital, or otherwise as would be understood by someone skilled in the art.

In one embodiment the guidance provided by the PISOPA after the various results have been generated will include but is not limited to conglomerating risk-weighted balance sheet assets, or otherwise as would be understood by someone skilled in the art.

In one embodiment the results and/or guidance provided by the PISOPA to inform other PISOP users may include but is not limited to informing the lender of the amount of risk-weighted assets which can be securitized.

In another embodiment the PISOP will utilize a database configured to store information including but not limited to information related to the clients, lenders, insurance providers, PISOP, PISOP user interface, PISOP selection module, or otherwise as would be understood by someone skilled in the art. This information may be accessed in order to inform the method.

The invention will now be described with reference to specific examples. It will be understood that the following examples are intended to describe embodiments of the invention and are not intended to limit the invention in any way.

Although the present invention and its advantages have been described in detail, it should be understood that various changes, substitutions and alterations can be made herein without departing from the spirit and scope of the invention as defined in the appended claims.

The present invention will be further illustrated in the following Examples which are given for illustration purposes only and are not intended to limit the invention in any way.

### EXAMPLES

In one embodiment, a male of age 57, with an annual premium of $1 million, paying $20 million, financed at prime—the policy is maximum overfunded. To secure $20 million of financing, the client needs to assign the lender a total of $1.5 million of additional collateral. Cash value is greater than the accrued loan draws in year 10 of the policy. The client's net cost starts at $30,868, rises to $294,077 by year 15, and to $298,115 by year 30 (the cost of funding falls in future years as deductible net cost of pure insurance rises through age 100 until it falls to nil). The internal rate of return starts at 55934% in year 1, falls to 870% in year 15, and to 264% in year 30 (anticipated mortality). Assumptions are based on a 3% cost of funds—the system and method can illustrate at any cost of funds, and can input a rate-hike algorithm to a defined cap.

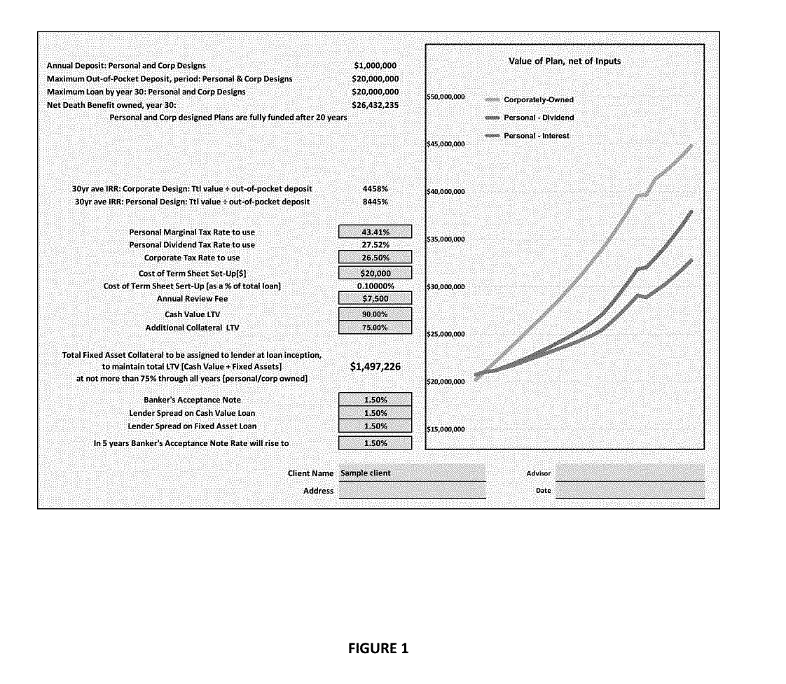

In one embodiment as depicted in FIG. 1, which shows the tested tax rates, with policies held personally or in a corporation, the annual premium deposit, the total premium deposit, and the amount of other collateral required to secure a loan against the policy (for example, $4 million of additional collateral for a $60 million loan). In the table input cells are in dark grey, and data in the other cells is generated by the software. Results are expressed as 30-year average internal rate of return. The tool is dynamic—the PISOPA may change the cost of funds, the cost of review, the marginal tax rate or client tax rate, and results will move in tandem with these changes.

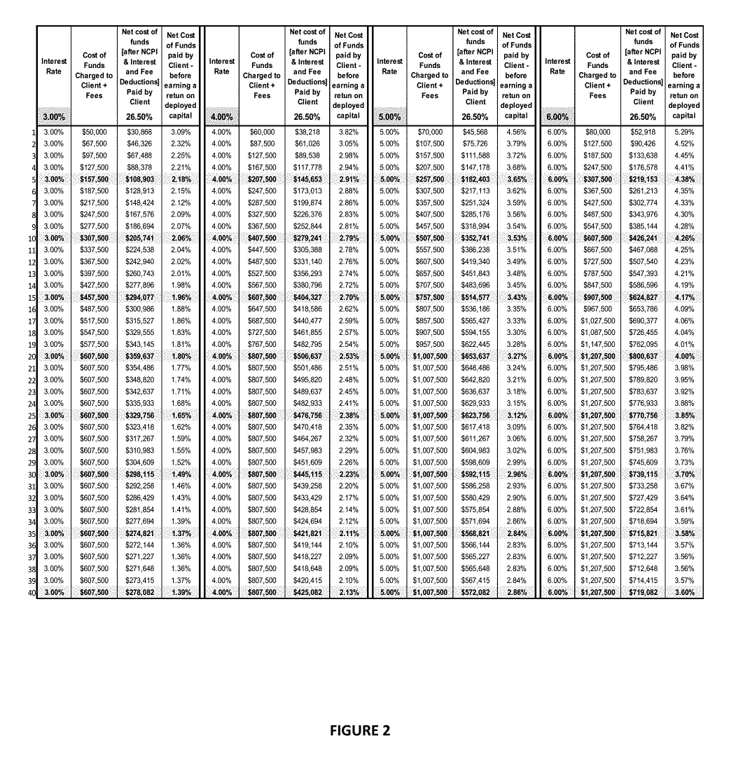

In one embodiment as depicted in FIG. 2, the cost of interest less the captured tax credits (the loan is to be used for investment purposes allowing clients to make use of regulations, for example in Canada S3-F6-C1) concerning interest deductibility is displayed. Insurance is a condition of credit and loan proceeds are used for investment purposes, allowing net cost of pure insurance deduction (for example as outlined in Canada in IT-309R2, and outlined in ITA 20(1)(e.2)). Net Cost of Funds is illustrated in future years to illustrate the benefit of proper leverage life insurance financing designs.

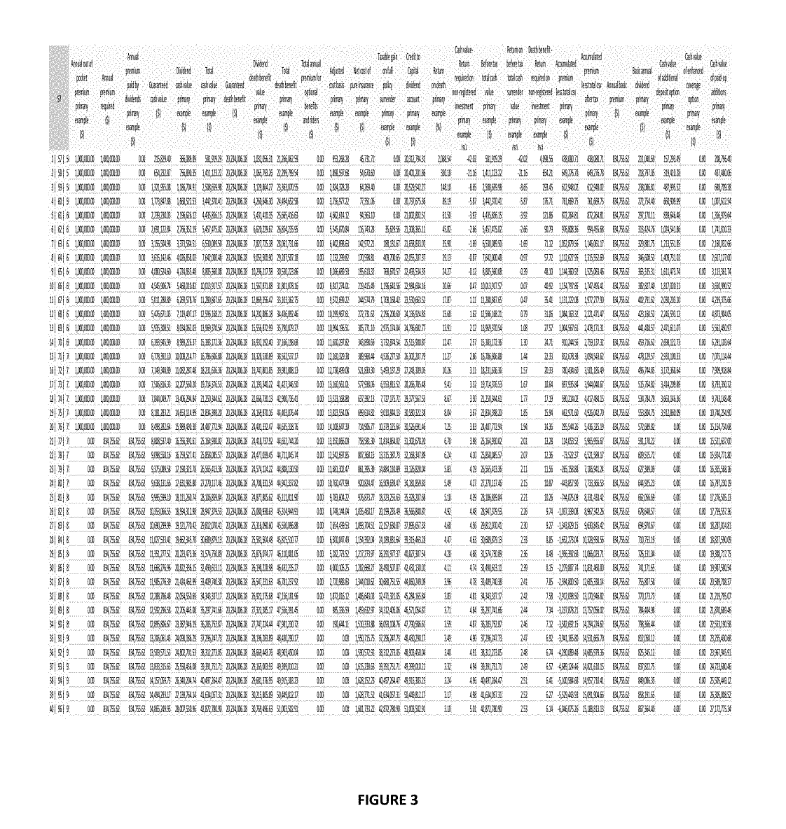

In one embodiment as depicted in FIG. 3, the raw data displayed is from the life insurance provider—the system and method is able to input data sets from all of the insurers in Canada.

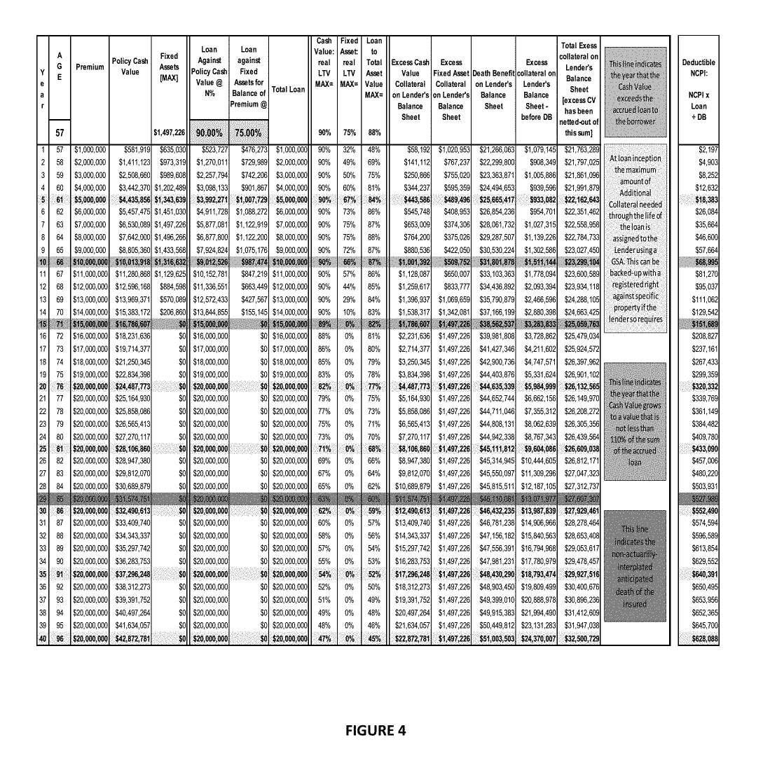

In one embodiment as depicted in FIG. 4, the table identifies the additional collateral required by the lender, the Loan-to-Value (also referred to as “LTV” herein) in each of 40 years, the excess cash value and excess other assets and the death benefit held as collateral by the lender through 40 years. The table also indicates when cash value is greater than accrued loan draws (as represented by the orange line), when cash value is greater than 110% of accrued loan draws (as represented by the green line—this is to inform the lender when they can extend more credit to the borrower), and standard mortality (as represented by the blue line). Data from this table—excess cash value—will be actuarially-risk-weighted to inform the lender of the value of the collateral that can be counted as Tier 2 capital.

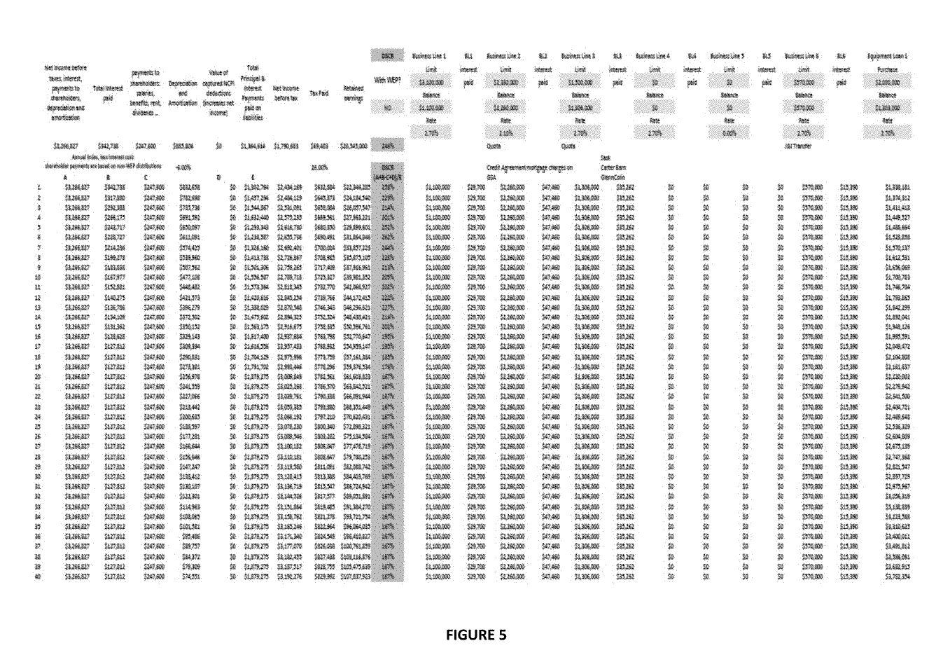

In one embodiment as depicted in FIG. 5, forward DSCR calculations are needed to ensure that the client who enters into a Leveraged-life plan is able to ensure that they can maintain a DSC ratio through all years, as required as part of credit covenants. The system and method provides these results.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

It will be appreciated that, although specific embodiments of the invention have been described herein for purposes of illustration, various modifications may be made without departing from the spirit and scope of the invention. In particular, it is within the scope of the invention to provide a computer program product or program element, or a program storage or memory device such as a solid or fluid transmission medium, magnetic or optical wire, tape or disc, or the like, for storing signals readable by a machine, for controlling the operation of a computer according to the method of the invention and/or to structure some or all of its components in accordance with the system or method of the invention.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Acts associated with the method described herein can be implemented as coded instructions in plural computer program products. For example, a first portion of the method may be performed using one computing device, and a second portion of the method may be performed using another computing device, server, or the like. In this case, each computer program product is a computer-readable medium upon which software code is recorded to execute appropriate portions of the method when a computer program product is loaded into memory and executed on the microprocessor of a computing device.

Further, each step of the method may be executed on any computing device, such as a personal computer, personal communication device, server, PDA, or the like and pursuant to one or more, or a part of one or more, program elements, modules or objects generated from any programming language, for example but not limited to languages such as C++, Java, PL/1, or the like. In addition, each step, or a file or object or the like implementing each said step, may be executed by special purpose hardware or a circuit module designed for that purpose.

The scope of the claims should not be limited by the preferred embodiments set forth in the examples, but should be given the broadest interpretation consistent with the description as a whole.

Having thus described in detail preferred embodiments of the present invention, it is to be understood that the invention defined by the above paragraphs is not to be limited to particular details set forth in the above description as many apparent variations thereof are possible without departing from the spirit or scope of the present invention.

What is claimed is:

1. A method for optimizing the selection of permanent life insurance policies for use in leverage life insurance structures comprising:
entering at least one raw data set from at least one insurance provider into a permanent insurance selection optimization platform input interface;
inputting at least one condition of credit and cost-of-funds data from a lender into a permanent insurance selection optimization platform input interface;
running a selection module to complete the optimization of the selection of permanent life insurance policies comprising;
gathering raw data from all permanent life insurance providers, and selecting constant guaranteed dividend rates;
analyzing internal rate of return as defined by:
death benefit divided by (cost of funds less cost of funds deductions less net cost of pure insurance deductions); and
calculating the optimal insurance provider and policy structure;
generating a result specifying the net annual cost to a client in all of the tested years;
generating a result specifying the internal rate of return delivered to the client for each of the tested years based on their net cost of funds;
generating a result specifying the collateral required by the lender to satisfy credit conditions through all tested years;
generating a result specifying the interpolated debt service coverage ratio for the client for all tested years;
generating a result specifying the excess cash value on the lender's balance sheet through all tested years;
generating a result specifying the actuarially risk-weighted for the lender to put same on its balance sheet as part of Tier 2 capital;
conglomerating risk-weighted balance sheet assets based on the generated results; and
informing the lender of the amount of risk-weighted assets which can be securitized.

2. The method for optimizing the selection of permanent life insurance policies for use in leverage life insurance structures of claim 1 wherein the at least one insurance provider raw data set used will include the source data for a permanent life insurance policy.

3. The method for optimizing the selection of permanent life insurance policies for use in leverage life insurance structures of claim 1 wherein a transactional fee may be imposed upon a client, lender, insurance provider, or other entity for use of the method.

4. A system for optimizing the selection of permanent life insurance policies for use in leverage life insurance structures comprising;
at least one client seeking a permanent life insurance policy;
at least one lender seeking to leverage life insurance structures;
at least one insurance provider desiring to provide a client with a permanent life insurance policy;
a permanent insurance selection optimization platform administrator to control and monitor the permanent insurance selection optimization platform;
a permanent insurance selection optimization platform further comprising;
a permanent insurance selection optimization platform user interface; and
at least one selection module; and
at least one database configured to store information related to the at least one client, the at least one lender, the at least one insurance provider, the insurance selection optimization platform, the permanent insurance selection optimization platform user interface, and the at least one selection module.

5. An optimization of the selection of permanent life insurance policies for use in leverage life insurance structures system comprising a microprocessor, a memory, and a communication interface and configured to:
permit a permanent insurance selection optimization platform administrator to enter at least one raw data set from at least one insurance provider into a permanent insurance selection optimization platform input interface;
permit a permanent insurance selection optimization platform administrator to input at least one condition of credit and cost-of-funds data from a lender into a permanent insurance selection optimization platform input interface;
permit a permanent insurance selection optimization platform administrator to run a selection module to complete the optimization of the selection of permanent life insurance policies comprising:
gathering raw data from all permanent life insurance providers, and selecting constant guaranteed dividend rates;
analyzing internal rate of return as defined by:
death benefit divided by (cost of funds less cost of funds deductions less net cost of pure insurance deductions); and
calculating the optimal insurance provider and policy structure;
generating a result specifying the net annual cost to a client in all of the tested years;
generating a result specifying the internal rate of return delivered to the client for each of the tested years based on their net cost of funds;
generating a result specifying the collateral required by the lender to satisfy credit conditions through all tested years;
generating a result specifying the interpolated debt service coverage ratio for the client for all tested years;
generating a result specifying the excess cash value on the lender's balance sheet through all tested years;
generating a result specifying the actuarially risk-weighted for the lender to put same on its balance sheet as part of Tier 2 capital;
conglomerating risk-weighted balance sheet assets based on the generated results; and
informing the lender of the amount of risk-weighted assets which can be securitized.
